(19) United States
(12) Patent Application Publication
(10) Pub. No.: US 2005/0239969 A1
(43) Pub. Date: Oct. 27, 2005

(54) Method for the production of polymeric hydroperoxides

(76) Inventors: Maximilian Dorn, Pullach (DE); Eberhard Hagel, Icking (DE)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 10/521,900

(22) PCT Filed: Jul. 30, 2003
(86) PCT No.: PCT/EP03/07113

§ 371 Date: May 4, 2005

(30) Foreign Application Priority Data
Jul. 19, 2002 (DE) 102 32 951.6

(51) Int. Cl. C08F 295/00

(52) U.S. Cl. 525/273

(57) ABSTRACT

Disclosed is a method for producing a polymeric hydroperoxide which forms a radical polymer but no low-molecular radical under redox influence. According to the inventive method, a synthetic polymer containing at least one tertiary hydroxyl group or olefin function is reacted with concentrated hydrogen peroxide and a concentrated mineral acid.

The invention relates to the synthesis of polymeric hydroperoxides which are suitable as redox initiators.

Graft or block copolymerization to form polymers without formation of a proportion of homopolymer has hitherto not been achieved by the methods of free-radical polymerization, since the initiators generally disintegrate thermally into two active free radicals. This results in undesired homopolymer being formed in addition to the desired copolymer. To reduce this problem, the copolymerization reaction has been carried out in a polymer latex to which catalyst and monomer are added. Since emulsion polymerization proceeds only in the swollen emulsified particles and not in the monomer droplets, the amount of undesired homopolymer can be reduced in this way. However, this neither solves the problem of homopolymerization completely nor does it make it possible to employ polymerization methods other than emulsion polymerization. To prepare polymers comprising hydroperoxide groups, the hydroperoxide groups have been introduced either by direct oxidation by means of air or benzoyl peroxide or by reaction of ester groups of the polymers with phosphorus pentachloride and reaction of the acid chloride groups formed with t-butyl hydroperoxide, or with perbenzoic acid to form peranhydrides which can in turn be cleaved to form hydroperoxides. It was therefore an object of the invention to provide a polymeric redox initiator in whose disintegration only one free-radical polymer is formed, while the other part of the disintegrated product is not a free radical and can therefore not trigger interfering homopolymerization.

This problem is solved according to the invention by a process for preparing a polymeric hydroperoxide which in a redox polymerization forms free-radical polymer but no low molecular weight free radical, which is characterized in that a synthetic polymer comprising at least one tertiary alcohol or olefin group is reacted with concentrated H₂O₂ and a concentrated mineral acid.

A polymeric hydroperoxide prepared in this way surprisingly disintegrates in a redox reaction to form a polymeric free radical and OH anions. The free OH radical to be expected as an intermediate is obviously converted so quickly into an OH anion that it cannot produce homopolymeric by-products. The occurrence of an OH anion in the disintegration of the hydroperoxide instead of the free OH radical to be expected makes the polymeric hydroperoxide obtained according to the invention suitable as initiator for copolymerizations which can be carried out at temperatures below the critical disintegration temperature of the hydroperoxide, which is about 90° C. The polymeric hydroperoxide prepared according to the invention therefore copolymerizes with monomers to form block or graft copolymers in the redox polymerization without interfering formation of homopolymers of the monomer.

The redox polymerization itself can be carried out by known methods. A temperature range from about 20 to 50° C. is suitable. For example, in the system styrene/acrylonitrile, the redox system used is advantageously an iron(II) salt and pyrophosphate, with reducing agents which are able to be used being, for example, glucose or another sugar, Rongalit, dithionites, hydrogensulfites, pyrosulfites, sulfites, ascorbic acid, thiomaleic acid, thiosalicylic acid, amines, mercaptans, mercaptides or benzoin, advantageously in the presence of emulsifiers and/or complexing agents.

Polymers which are suitable for use in the process of the invention are synthetic polymers which comprise at least one tertiary alcohol group or an olefin group but have no further groups which are reactive toward the peroxidation reagent used. For the purposes of the invention, a tertiary olefin is a polymer comprising at least one 2-propenyl group. Examples of polymers which can be used successfully in the process of the invention are polysiloxane polyols, i.e. silicones which contain free OH groups and are liquid or soluble in nonaqueous solvents, polyester polyols, polyether polyols such as polyethylene glycol having a methallyl ether end group, polyalkanols, polycarbonates, polyurethanes and vinyl polymers. If the polymers used contain no tertiary OH groups, these can be introduced by customary methods, for example by partial cleavage of ether or ester bonds present in the polymer, addition of water onto terminal double bonds, copolymerization into the polymer of hydroperoxides containing olefin or alkyne groups, e.g. 3-methylbut-2-yne 3-hydroperoxide, copolymerization into the polymer of monomers containing OH groups or monomers which can be converted into these, e.g. methallyl alcohol or methallyl chloride, or by introduction of hydroperoxides having an alcohol function by means of esterification, isocyanate or etherification reactions. Examples are hydroperoxides derived from hexylene glycol or methallyl alcohol. Tertiary olefinic end groups can be obtained analogously by addition or polymer-analogous reaction of unsaturated alcohols such as 3-methylbut-2-en-3-ol or 3-methylbut-2-yn-3-ol.

The process can be carried out with or without solvent depending on the properties of the polymer polyol. Liquid polymer polyols can generally be used without additional solvent for the peroxidation reaction. Relatively high molecular weight viscous or solid polymers have to be dissolved. Possible solvents are the customary organic solvents. In the case of polysiloxane polyols, it is possible to use, for example, lower alcohols, alkanes, in particular relatively long-chain alkanes, and likewise aromatic solvents such as toluene. In the case of polyester polyols or other polymers, the solvents customary for these are used, as long as they are inert toward the peroxidation reagent.

The hydroperoxidation reagent used according to the invention comprises concentrated H₂O₂, preferably H₂O₂ having a concentration of from 50 to 70%, and a concentrated mineral acid. As mineral acid, sulfuric acid having a concentration of from 50 to 80% has been found to be particularly useful. Other concentrated mineral acids which together with concentrated H₂O₂ are known as peroxidation agents can also be used, typically phosphoric acid, perchloric acid, toluene-sulfonic acid or amidosulfonic acid, etc.

Redox polymerization initiators prepared according to the invention preferably have a plurality of hydroperoxy groups and therefore react simultaneously in a plurality of positions during the polymerization reaction. However, it is also possible to introduce only a single polymerization-active hydroperoxy function or a predetermined small number of polymerization-active hydroperoxy functions, for example in the case of chain polymers which are hydroperoxidized at one end position, both end positions or in the case of branched chains, at the various end positions. Thus, polyester polyols and polyether polyols can typically be converted according to the invention into the hydroperoxides which can then, in the redox copolymerization, be grafted or joined to further polymer blocks only at these chain ends.

The temperatures to be employed in the process of the invention are determined by the thermal stability of the hydroperoxide group which disintegrates at about 90° C. The hydroperoxidation reaction is advantageously carried out at temperatures of from about 10 to about 60° C. Here, it can be advantageous to commence at a relatively low reaction temperature in the region of room temperature and then to complete the reaction at higher temperatures up to about 60° C., depending on the desired degree of hydroperoxidation. Preference is given to employing temperatures in the range from room temperature to 50° C.

Since the polymers used in the process of the invention frequently contain, as a result of their preparation, small amounts of metallic impurities which can catalytically decompose peroxide groups, the reaction is advantageously carried out in the presence of a complexing agent for metals. Possible complexing agents are all complexing agents which are stable under the reaction conditions of the hydroperoxidation reaction. Examples are complexing agents based on phosphonic acid, e.g. Turpinal SL (1-hydroxyethane-1,1-diphosphonic acid), which are needed and also compounds whose complexing group is derived from iminodiacetic acid, hydroxylquinoline, thiourea, guanidine, dithiocarbamate, hydroxamic acid, amidoxime, aminophosphoric acid, polyamino ethers, mercapto ethers, 1,3-dicarbonyl ethers and crown ethers. Such complexing agents are known to those skilled in the art for the various metal impurities which may be present and require no further explanation here.

The polymeric hydroperoxides prepared according to the invention are suitable as redox initiators, e.g. for the grafting of monomers such as styrene, vinyl acetate, acrylonitrile, acrylates and methyl methacrylate.

The following examples illustrate the invention.

### Preparation of Polysiloxane Polyol As Starting Material

A. 1000 gram of a polydimethylhydrogensiloxane having terminal SiH groups (active hydrogen content: 0.055% by weight) are placed in a stirred 2 liter three-necked flask provided with a reflux condenser, the flask is flushed with nitrogen and heated to 90° C. 52.03 gram of 2-methyl-3-buten-2-ol which had been admixed beforehand with 0.5 gram of a catalyst solution containing 1.1% by weight of platinum(IV) (hexachloroplatinic acid in isopropanol, Speier catalyst) are introduced via a superposed dropping funnel over a period of 60 minutes. The addition is carried out at such a rate that the boiling point of the reaction mixture is not exceeded. After the end of the addition, another 0.2 g of the catalyst solution is added, and the mixture is stirred at 100° C. for a further 60 minutes. Excess methyl butenol is taken off at 100° C. and 5 mbar on a rotary evaporator and the product obtained is filtered through a pressure filter. The successful conversion into the corresponding hydrosilylation product was confirmed by ¹H NMR.

B. 1000 gram of a polydimethylhydrogensiloxane having lateral SiH groups (active hydrogen content: 0.17% by weight) are placed in a stirred 2 liter three-necked flask provided with a reflux condenser, the flask is flushed with nitrogen and heated to 90° C. 156.1 gram of 2-methyl-3-buten-2-ol which had been admixed beforehand with 0.5 gram of a catalyst solution containing 1.1% by weight of platinum(IV) (hexachloroplatinic acid in isopropanol, Speier catalyst) are introduced via a superposed dropping funnel over a period of 60 minutes. The addition is carried out at such a rate that the boiling point of the reaction mixture is not exceeded. After the end of the addition, another 0.2 g of the catalyst solution is added, and the mixture is stirred at 100° C. for a further 60 minutes. Excess methyl butenol is taken off at 100° C. and 5 mbar on a rotary evaporator and the product obtained is filtered through a pressure filter. The successful conversion into the corresponding hydrosilylation product was confirmed by ¹H NMR.

### EXAMPLE 1

Preparation of polysiloxane hydroperoxide from polysiloxane polyol having a chain length of 30-40, 8-10 tertiary OH side groups, 4.15% by weight of OH, using an alcoholic solvent

Raw Materials

| | | |
|---|---|---|
| H₂O₂ - 70% strength | 300 g | |
| H₂SO₄ - 72% strength | 200 g | |
| Turpinal SL | 5 ml | (complexing agent based |
| | | on phosphonic acid) |
| Silicone copolyol | 500 g | (about 1.22 mol of OH |
| | | groups) |
| Ethanol | 125 g | |

Method

H₂O₂, H₂SO₄ and Turpinal are placed in a reaction vessel at about 25° C. The mixture of silicone copolyol/ethanol is added dropwise at about 30° C. over a period of about 30 minutes. The mixture is heated to 35° C. and stirred for 30 minutes, then heated to 50° C. and stirred for a further 45 minutes. After cooling to 25° C., 500 g of 5% strength (NH₄)₂SO₄ solution are added, the mixture is stirred for 5 minutes and separated for 40 minutes. (712 g of slightly turbid, aqueous phase).

The organic phase is washed another four times with 500 g each time of 10% strength (NH₄)₂SO₄ solution, separation time in each case 45 minutes, aqueous phases clear.

The organic phase is allowed to stand until the next day and aqueous phase is separated off once more.

Product

520 g of viscous, turbid liquid.

Active oxygen content: 3.01% (corresponding to 6.2% by weight of OOH groups, about 80% conversion of the OH groups).

### EXAMPLE 2

Preparation of polysiloxane hydroperoxide from polysiloxane polyol using a long-chain alkane as solvent

Raw Materials

| | | |
|---|---|---|
| H₂O₂ 70% strength | 300 g | |
| H₂SO₄ - 72% strength | 200 g | |
| Turpinal SL | 5 ml | |
| Polysiloxane polyol | 500 g | (about 1.22 mol of OH |
| from Example 1 | | groups) |
| Isododecane | 300 g | |

Method

H₂O₂, H₂SO₄ and Turpinal are placed in a reaction vessel at about 25° C. The solution of the silicone copolymer in isododecane is added dropwise over a period of 40 minutes to 35° C. The mixture is heated to 35° C. and stirred for another 1 hour, then heated to 50° C. and stirred for a further 30 minutes. After cooling to 25° C., the phases are separated for 15 minutes (aqueous phase about 455 g). The organic phase is washed three times with 400 g each time of 5% strength (NH₄)₂SO₄ solution (separation time in each case about 45 minutes). The organic phase is stirred with anhydrous Na₂SO₄ for 30 minutes and filtered.

Product

785 g of clear, viscous liquid

Active oxygen content: 2.1% (corresponding to 4.5% by weight of OOH groups, about 87% conversion of the OH groups)

Isododecane content: about 34%.

### EXAMPLE 3

Preparation of polysiloxane hydroperoxide from polysiloxane polyol having a chain length of from 15 to 20, terminal tertiary OH groups, 2.75% by weight of OH, without solvent

Raw Materials

| | | |
|---|---|---|
| H₂O₂ - 70% strength | 240 g | |
| H₂SO₄ - 72% strength | 160 g | |
| Turpinal SL | 2 ml | |
| Silicone copolyol | 370 g | (about 0.6 mol of OH |
| | | groups) |

Method

H₂O₂, H₂SO₄ and Turpinal are placed in a reaction vessel at about 25° C. The silicone copolyol is added dropwise at about 30° C. over a period of 30-40 minutes. The mixture is heated to 35° C. and stirred for 90 minutes, then heated to 50° C. and stirred for a further 30 minutes. After cooling to 25° C., the phases are separated for 30 minutes (375 g of clear, aqueous phase).

The organic phase is washed three times with 300 ml each time of 5% strength (NH₄)₂SO₄ solution (separation time in each case 30 minutes, aqueous phases clear, organic phase turbid). The organic phase is stirred with 30 g of anhydrous Na₂SO₄ for 30 minutes and filtered.

Product

358 g of clear, colorless, somewhat viscous liquid.

Active oxygen content: 2.52% (corresponding to 5.2% by weight of OOH groups, about 100% conversion of the OH groups).

### EXAMPLE 4

Preparation of polysiloxane hydroperoxide from polysiloxane polyol having a chain length of 50, terminal tertiary OH groups, 0.89% by weight of OH, using an aromatic solvent

Raw Materials

| | | |
|---|---|---|
| H₂O₂ - 70% strength | 300 g | |
| H₂SO₄ - 72% strength | 200 g | |
| Turpinal SL | 2 ml | |
| Silicone copolyol | 600 g | (about 0.314 mol of OH |
| | | groups) |
| Toluene | 200 g | |

Method

H₂O₂, H₂SO₄ and Turpinal are placed in a reaction vessel at about 25° C. The solution of the silicone copolyol in toluene is added dropwise at a temperature of up to 35° C. over a period of about 40 minutes. The mixture is stirred at 35° C. for 1 hour, heated to 50° C. and stirred for a further 30 minutes. After cooling to 25° C., the phases are separated for 20 minutes.

The organic phase is washed three times with 400 ml each time of 5% strength (NH₄)₂SO₄ solution (separation time in each case 30-40 minutes). The organic phase is stirred with 40 g of anhydrous Na₂SO₄ for 30 minutes and filtered.

Product

343 g of clear, slightly yellowish liquid

Active oxygen content: 0.65% (corresponding to about 1.33% by weight of OOH groups, about 96% conversion of the OH groups).

Toluene content: about 18%.

### EXAMPLE 5

Preparation of polyethylene glycol hydroperoxide using an end-group-modified polyethylene glycol methallyl ether (MeO-PEG 23-methallyl).

An end-group-modified polyethylene glycol (PEG) having about 23 ethylene oxide units (EO) and methallyl ether and methyl ether end groups is converted by means of hydrogen peroxide under acid conditions into a terminal hydroperoxide.

Raw Materials

| | |
|---|---|
| H₂O₂ - 70% | 160 g |
| H₂SO₄ | 106 g |
| MeO-PEG 23-methallyl (MW 1100) | 360 g |

Method

H₂O₂ - 70% and H₂SO₄ are placed in a reaction vessel at about 28° C. The MeO-PEG 23-methallyl is added dropwise over a period of 40 minutes with the temperature being kept at or below 35° C. The mixture is stirred for 2 hours while slowly increasing the temperature to 50° C. After cooling to 22° C., the mixture is washed five times with 400 ml of saturated (NH₄)₂SO₄ solution (separation time in each case about 15 minutes). The organic phase is stirred with 50 g and 20 g of anhydrous Na₂SO₄, respectively, dried and filtered, in each case for about 30 minutes.

Yield: 495 g Active oxygen: 1.12% total, contamination: 0.6% of H₂O₂ (0.3% of AO), i.e. 58% of the terminal olefin groups have been converted into PEG hydroperoxide.

### EXAMPLE 6

Preparation of polyethylene glycol hydroperoxide from an end-group-modified PEG methallyl ether.

An end-group-modified PEG having about 23 EO units and methallyl ether and methyl ether end groups is converted by means of hydrogen peroxide under acid conditions in the solvent butyl acetate into a terminal hydroperoxide.

Raw Materials

| | |
|---|---|
| H₂O₂ - 70% | 80 g |
| H₂SO₄ | 53 g |
| MeO-PEG 23-methallyl (MW 1100) | 145 g |
| Butyl acetate | 150 g |

Method

H₂O₂ - 70% and H₂SO₄ are placed in a reaction vessel at about 27° C. The MeO-PEG 23-methallyl dissolved in butyl acetate is added dropwise over a period of 35 minutes while keeping the temperature at or below 35° C. The mixture is stirred for another 1 hour while slowly increasing the temperature to 50° C. After cooling to 22° C., the mixture is washed three times with 200 ml of saturated (NH₄)₂SO₄ solution (separation time in each case about 15 minutes). The organic phase is stirred with 50 g and 20 g of anhydrous Na₂SO₄, respectively dried and filtered, in each case for about 30 minutes.

Yield of organic phase: 385 g Active oxygen: 1.58% total, contamination: 2.2% of H₂O₂ (0.38% of AO), i.e. 84% of the terminal olefin groups have been converted into PEG hydroperoxide.

1. A process for preparing a polymeric hydroperoxide which in a redox reaction forms free-radical polymer but no low molecular weight free radical, characterized in that a synthetic polymer comprising at least one tertiary hydroxyl group or olefin function is reacted with concentrated hydrogen peroxide and a concentrated mineral acid.

2. The process as claimed in claim 1, characterized in that H₂O₂ having a concentration of from 50 to 70% is used.

3. The process as claimed in claim 1 or 2, characterized in that sulfuric acid having a concentration of from 50 to 80% is used as concentrated mineral acid.

4. The process as claimed in any of the preceding claims, characterized in that the polymer is used as a solution in an organic solvent.

5. The process as claimed in any of the preceding claims, characterized in that a polysiloxane polyol, polyether polyol or polyester polyol is used as starting material.

6. The process as claimed in any of the preceding claims, characterized in that the reaction is carried out at a temperature of from +10 to +60° C.
